(19) United States
(12) Patent Application Publication
(10) Pub. No.: US 2016/0371705 A1
(43) Pub. Date: Dec. 22, 2016

(54) DATA PROCESSING SYSTEM

(71) Applicant: Ingo STUCKMANN, Muelheim (DE)

(72) Inventor: Ingo STUCKMANN, Muelheim (DE)

(21) Appl. No.: 14/901,493

(22) PCT Filed: Apr. 3, 2014
(86) PCT No.: PCT/EP2014/056694

§ 371 Date: Dec. 28, 2015

(30) Foreign Application Priority Data
Jun. 25, 2013 (DE) 10 2013 106 600.3

(51) Int. Cl. G06Q 30/00; G06Q 40/04

(52) U.S. Cl. CPC G06Q 30/018; G06Q 40/04

(57) ABSTRACT

Data processing system and process designed for determining, calculating and quantifying the carbon footprint corresponding to an activity and/or a product, and executing an energy-equivalent neutralisation of the same, by means of an electronic value trade.

The invention relates to a data processing system according to claim 1 and to a process for determining, analysing and offsetting a carbon footprint according to claim 9. The invention relates in particular to a data processing system and a process for determining, analysing and offsetting the carbon footprint of an activity and/or a product and a value trade linked to this.

The term “carbon footprint” has been developed as an appropriate means of quantifying the environmental impact of emissions, in order to calculate the climatic effects of activities, services and other actions and of products over their life cycle. The issue of climate change and how to positively influence the CO₂ balance has become one of the major challenges for mankind and for our ecosystem.

The conventional term “carbon footprint” (or CO₂ footprint) is a quantitative measure for the total amount of carbon dioxide emissions (measured as CO₂), generated by an activity or action or during the manufacture of a product, or that arises over the life stages of a product. The totality of all emissions that are produced is referred to as the carbon footprint. This includes all greenhouse gases or any additional factors that produce emissions so that the carbon footprint is the quantitative measure in kg for carbon dioxide emissions (measured as CO₂) including greenhouse gases.

Carbon dioxide emissions (measured as CO₂) and greenhouse gas emissions (measured as CO₂ equivalents) are typically stated in terms of weight per annum—or in the case of vehicles for example, in grammes per kilometre.

It is now possible to calculate the carbon footprint for individuals, institutions, corporations and even for entire countries and events, as well as for everyday activities (e.g. drinking a cup of coffee) etc. In this way it is possible to compare the carbon footprints of several alternatives and to choose the one that is most environmentally friendly.

Another possibility is to somehow neutralise the respective carbon footprint, e.g. to use the calculation result to take adequate measures to neutralise an equivalent amount of CO₂, for example by producing renewable energy or taking other climate-friendly measures such as planting a corresponding number of trees or plants.

Increasingly the CO₂ emissions produced by activities or during the useful life of a product are being “offset or neutralised” by the monetary value required to reduce a corresponding quantity of greenhouse gases and emissions somewhere else in the world. This can be done, for example, by climate protection projects, such as building wind, hydro or geothermal power stations, and by other measures that reduce greenhouse gases (e.g. afforestation projects) or other projects that conserve resources (e.g. plant protection projects).

However, it is first of all necessary to provide a suitable process for determining the carbon footprint. In the prior art there are various methods for determining the carbon footprint.

For example, there is British Standard PAS 2050: 2008. This is essentially based on the life cycle assessment standard ISO 14040 ff. For various reasons, however, it has not achieved general international acceptance.

In Germany, the Öko-Institut [Institute for Applied Ecology] and the Federal Ministry for the Environment are critical of the bias of the carbon footprint in the calculation, because there is no consideration of all the other harmful categories, such as emissions of air pollutants, or of resource requirements.

Another problem is that, as a rule, the end user is not able to do much with the carbon footprint as a value because, for example, there is no means of comparison or link to actions to neutralise the carbon footprint.

Moreover, software solutions to calculate the carbon footprint are already known in the prior art.

This raises the question of how to make a direct correlation between neutralising energy production and the determination of the carbon footprint. Furthermore, most calculation programs are based on available databases of existing CO₂ balances and single values. For example, the WWF computer offers online calculation of the footprint for each household based on statistical data. This assumes that the national annual per capita average is 10 tonnes of CO₂ for mobility and living.

However, one of the disadvantages is that detailed calculations are very costly and there is a lack of data available for most products and activities to enable the existing methods to produce results. On the one hand, there are no CO₂ data available for imports (raw materials and products) from various different countries and, on the other hand, the data that are available do not reflect the current CO₂ balance, since the figures are dynamically variable.

Given this background, the object of the invention is to provide a process and a data processing system that is designed to determine, calculate and quantify a carbon footprint corresponding to an activity and/or a product, and to execute an energy-equivalent neutralisation of the same, that overcomes the above-mentioned disadvantages and that is universally applicable, making it suitable for nearly all products and activities.

The object of the invention is achieved by a data processing system according to claim 1 and a process according to claim 9.

The fundamental concept of the present invention is to provide a data processing system (zero-emission calculator) with a selection and display operator that uses CO₂ equivalence parameters for activities and products from the data stored in a data memory to calculate the corresponding carbon footprint for the activities or products entered by the user. In a particular embodiment of the invention, the CO₂ equivalence parameters for activities or products are calculated from values that correlate with or correspond to statistically determined values for a product/value balance. Thus, for example, a balance from all trade balances (domestic trade and foreign trade balances) such as the GDP (gross domestic product) of the corresponding sectors and their external trade balances are used as a suitable product/value balance. Therefore, a category is first of all defined for each sector and this might include additional subcategories. Since each activity and especially each product has a monetary value (currency), it is possible to assign a CO₂ equivalence parameter to each activity and each product from the total GDP, to correspond to the relevant percentage of GDP of the sector, so that this can be allocated to a specific carbon footprint. Ultimately, it is possible to consider the global GDP of all international foreign trade balances, from which values can be extracted for each product and each activity.

The (extracted) values for each category and subcategory of all products and activities that correlate to the GDP values are entered and classified in a data memory. According to the invention this provides a data memory or a database, preferably stored in a data memory, of classified equivalence data sets, corresponding to a category and also to the percentage of GDP of the relevant sector. A selection operator is also provided to assign a CO₂ equivalence parameter to the respective activity or product.

The functional relationship between the factors involved can therefore be represented as follows:

CF=CF(A,P)

EP=EP(VB,A,P)

V=V(CF)=V(A,P,EP)

CF: Carbon Footprint (=CO₂ Footprint)

EP: Equivalence Parameter

VB: Value Balance (trade balance value)

A: Activity

P: Product

V: Value

The value V and, therefore, the GDP percentage value of each sector and therefore the percentage of each service and product correlates with the corresponding energy/CO₂ balance. Thus, the carbon footprint is in turn a function of the variables (activity or product). The correlation is represented by the CO₂ equivalence parameter, so that in turn the CO₂ equivalence parameter EP is a function of the activity A or the product P and the percentage of GDP.

There is therefore a CO₂ equivalence parameter available for every product or product category and for every activity or activity category, which can be used by a quantification operator to determine the corresponding amount of CO₂.

A second aspect of the invention is that the data processing system is equipped with a quantification operator that, after the step of determining the amount of CO₂ for a product/activity, determines from this the energy or energy equivalent (green energy or zero emission energy) that is required to “zero” or to neutralise the CO₂ value. If, for example, the determined value is 10 kWh of energy, the equivalent amount of energy can be generated from a renewable energy source.

In turn, the amount of energy determined is set against a value V (value of zero emission), which can be traded by value trading (certificates, emission credits, funds, securities, options, unit certificates, shares or similar). The determined value (monetary value) can be transformed into a shareholding (for example, in a renewable power station) by means of a job execution facility to ensure that this amount of energy is actually produced.

In a development of the invention, the nominal value of the security (e.g. zero emission certificate) can be used at regular intervals, e.g. every year, to produce the originally calculated amount of renewable (green) energy that was needed to produce the product/activity of the original calculation. This form of share also produces annual monetary returns on the share.

A further aspect of the invention is that it provides for the execution of an energy-equivalent neutralisation of a carbon footprint corresponding to an activity and/or a product by means of electronic value trading. In this context (as mentioned above), value trading means any type of trading with certificates, emission credits, funds, securities, options, share certificates or similar. This process ensures for example that, after determining the equivalent value that forms the basis of the value trade, the energy production is automatically activated by the data processing system and actually takes place.

The invention therefore provides a data processing system designed for determining, calculating and quantifying a carbon footprint, and executing an energy-equivalent neutralisation of the same, corresponding to an activity and/or a product by means of electronic value trading or similar comprising:

a. a display and input device for inputting variables, in particular in the form of activity and/or product data;

b. a selection operator that selects CO₂ equivalence parameters for the activity and/or product corresponding to the variables from the data stored in a data memory;

c. a first quantification operator to quantify the amount of CO₂ corresponding to the CO₂ equivalence parameters relating to the activity (activities) or product (products);

d. a second quantification operator to quantify an amount of energy or to determine an energy equivalence parameter to offset the determined amount of CO₂;

e. a third quantification operator to quantify a value corresponding to the amount of energy or the energy equivalence parameter; and

f. a job execution facility to execute a value trade corresponding to the quantified value.

A preferred embodiment of the invention provides a data processing system, in which the first quantification operator uses a monetary value (V) to quantify the amount of CO₂ from the CO₂ equivalence parameters for the activity or product, in particular a monetary value determined from the percentage of GDP of the corresponding trade balance.

Another preferred embodiment of the invention provides a data processing system, which has a display and input device with an input mask with input fields for entering variables. These variables are data about activities or products. For example, a variable can be a certain make of vehicle or even a cup of coffee.

Advantageously, it provides for the data memory to have an interface to allow the CO₂ equivalence parameters for the activity or product to be manually or automatically changed. The values can therefore be updated manually or automatically to reflect changes in GDPs.

It is also advantageous if the quantification operator determines the amount of CO₂ using the up-to-date data in the data memory that correspond to the entered variable(s). In a preferred embodiment, the data processing system has a single quantification operator that is capable of performing all the quantification operations. Alternatively, two or more such operators can be provided to perform separate operations.

In another preferred version, a coupling facility is provided to activate the generation, in a power production plant, of the amount of energy determined by the corresponding quantification operator to correspond to the value determined from value trading. This guarantees that the energy production is effected or activated by the coupling facility of the data processing system.

The invention also provides a process for determining, calculating and quantifying a carbon footprint corresponding to an activity and/or a product, and executing an energy-equivalent neutralisation of the same, by means of an electronic value trade or similar using a data processing system as previously described comprising at least the following steps:

a. Inputting variables into the input device in the form of activity and/or product data;

b. Selecting CO₂ equivalence parameters for the activity or product from the data memory to correspond to the variables;

c. Quantifying the amount of CO₂ corresponding to the CO₂ equivalence parameter(s) for the activity or product;

d. Quantifying the amount of energy or determining an energy equivalence parameter in order to neutralise the determined amount of CO₂;

e. Quantifying a value (monetary value) corresponding to the determined amount of energy or the energy equivalence parameter and executing a value trade corresponding to the quantified value (monetary value).

Advantageously, the value trade is the sale of a share, the sale of a certificate or a security or similar, in particular a share in a renewable energy plant or an emission-neutralising facility. Emission neutralising facilities are all types of facilities that serve to neutralise the equivalent of the determined carbon footprint such as e.g. tree plantations or afforestation projects.

In a preferred embodiment of the process according to the invention, the generation of the determined amount of energy in the power production plant is activated as a result of the execution of the value trade via a technical coupling facility. Thus, for example by means of an input device, the activation of the sale of a 1000 US$ share in a wind farm can activate the generation of a corresponding amount of energy in the wind farm by clicking on the “Buy” button.

Other advantageous developments of the invention are outlined in the subordinate claims or are outlined in more detail below based on the figures, together with the description of the preferred embodiment of the invention. The figures show:

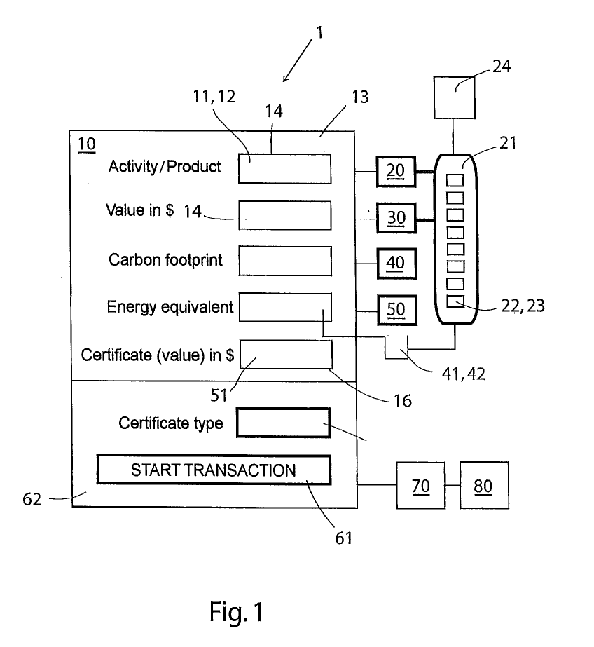

FIG. 1 A schematic overview of a data processing system according to the invention;

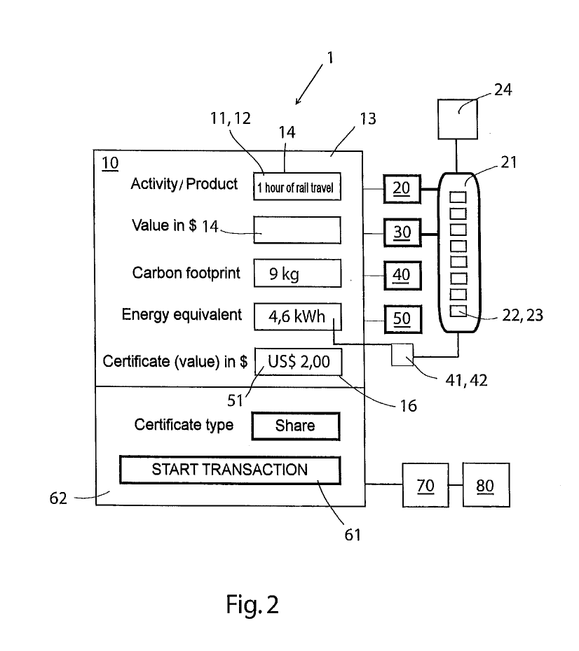

FIG. 2 A schematic overview of the data processing system according to the invention according to FIG. 1 in a different operating mode;

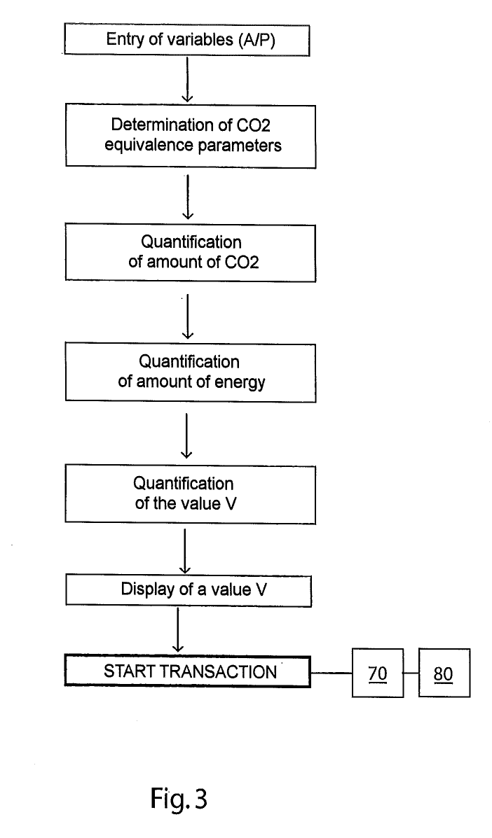

FIG. 3 A schematic flow diagram of the process according to the invention.

In this context the expression “data processing system” refers to a digital data processing device, essentially known to a person skilled in the art, which for example has a bus system, to which is attached a digital processor, manual data input terminals, one or more memories (one of which contains the control program) and output devices, such as a monitor and a printer. The system can be coded in any of the known program languages. According to the invention, a special data memory is provided with equivalence parameters, a selection operator and quantification operators.

FIGS. 1 and 2 show a schematic overview of the data processing system according to the invention 1 with a display and input device 10 for entering variables 11, 12 in the form of an activity 11 and/or a product 12 into the provided input fields 14 of an input mask 13. For example, in FIG. 2, a user inputs the activity “1 hour of rail travel”.

In addition, a selection operator 20 is provided and this selects CO₂ equivalence parameters 22, 23 for the activity and/or product from the data stored in a data memory 21 to correspond to the variables 11, 12, a first quantification operator 30 also being provided in the data processing system 1 to quantify the amount of CO₂ corresponding to the CO₂ equivalence parameters 22, 23 for the activity or product. That means that in the present embodiment the quantification operator 30 selects the CO₂ equivalence parameter 22 for the activity from the database and from this determines a quantity of 9 kg of CO₂, for example, which is delivered to the display field 15 to indicate the carbon footprint.

A second quantification operator 40 is provided to quantify the amount of energy 41 or to determine an energy equivalence parameter 42 necessary to offset, i.e. neutralise, the determined quantity of 9 kg of CO₂.

A third quantification operator 50 serves to quantify the value 51 (in this instance, the monetary value 51) corresponding to the amount of energy 41. The determined value (e.g. US$ 2.00 in this case) is displayed in the display field 16 of the display and input device 10.

In addition, the data processing system 1 has a job execution facility 60 to execute a certificate trade, a security trade or similar corresponding to the quantified value 51. The job execution facility 60 can be activated by means of an activation button 61.

FIGS. 1 and 2 also show that an interface 24 is provided, to update or to change the energy equivalence parameters 41, 42 in the data memory 21. This can be done manually or else via an automated update process.

In the present embodiment, the activation button is used to execute a certificate purchase in accordance with a selected type of certificate 62 to the value 51 (in this case

US$ 2.00) and, via a coupling facility 70, to activate the generation of a corresponding amount of energy (in this case: 4.6 kWh) in an energy production plant 80.

FIG. 3 shows a flow diagram illustrating the process steps of a preferred embodiment of the process according to the invention. First of all a variable in the form of an activity or a product is input into the input mask 13 of the data processing system 1. A selection operator allocates the entry to a category or subcategory in the data memory 21 and from this determines the CO₂ equivalence parameters 22, 23 stored for the category. The quantification operator 30 then calculates the amount of CO₂ from the GDP-correlated value corresponding to the CO₂ equivalence parameters 22, 23.

The amount of energy 41 required to neutralise the determined quantity of CO₂ is then quantified. Alternatively, an energy equivalence parameter 42 could also be determined, e.g. the number of trees that need to be planted to neutralise the determined quantity of CO₂.

In a further step, the value V (monetary value) corresponding to the determined amount of energy 41 or the energy equivalence parameter 42 is quantified. This value is shown on the display of the data processing system next to the amount of CO₂.

A transaction button can be used to effect the purchase of a security or certificate or similar corresponding to the quantified value V (monetary value). In the present embodiment, there is a suitable coupling facility 70, which activates the actual generation of the corresponding amount of energy 41. For example, this can effect a switching process and therefore trigger the generation of the energy.

The design of the invention is not restricted to the above-mentioned preferred embodiment of the invention. In fact there are a number of possible variants, which use the outlined solution, even though the execution might be essentially different. The invention is therefore not restricted to a data processing system or process for determining and neutralising a carbon footprint but can be used for different types of footprint associated with the use of resources. Similarly, the invention is not restricted to currencies, such as US dollars, but can use any suitable currency or monetary substitute (credits, zero emission credits and similar) as a coefficient in determining the “value” and for the purposes of value trading.

In a preferred development of the invention, the additional factors that further subdivide the sectors, such as sections*, departments*, groups*, classes*, firms, products or products from a particular firm, can be considered in determining the equivalence parameters and more generally in determining the value of the sector/value balances, by correlation with monetary flows, the terms marked with * being taken from NACE Revision 2 for example, which officially divides the national balances into subcategories.

In addition to the general meaning of an “economic sector”, for the purposes of this invention the term “sector” is also understood to mean all sections, departments, groups and classes of goods defined in NACE Rev. 2 for example, as well as any subgroups or subclasses.

In principle, an energy equivalence parameter is always calculated for neutralising the footprint. According to the invention this can also be calculated directly without intermediate CO₂ equivalence parameters, the energy equivalence parameters for the amount of energy required for the product/activity being calculated directly.

The following variations are possible. Starting from an energy balance, it is possible to derive the CO₂ balance, and from this the CO₂ equivalence parameters, and then from this the energy equivalence parameters and the value parameters or, alternatively, the energy equivalent of a product/activity can be determined directly and the value parameters can then be determined.

1. A data processing system designed to determine, calculate and quantify a carbon footprint corresponding to an activity and/or a product, and execute an energy-equivalent neutralisation of the same, by means of an electronic value trade or similar comprising
a. a display and input device for inputting variables;
b. a selection and display operator, which selects CO₂ equivalence parameters for the activity and/or product from the data stored in a data memory to correspond to the variables;
c. a first quantification operator for quantifying the amount of CO₂ from the CO₂ equivalence parameters for the activity and/or product;
d. a second quantification operator for quantifying an amount of energy or for determining an energy equivalence parameter to offset the determined amount of CO₂;
e. a third quantification operator for quantifying a value corresponding to the amount of energy or the energy equivalence parameter; and
f. a job execution facility to execute a certificate trade, a security trade or similar corresponding to the quantified value).

2. The data processing system according to claim 1, wherein the first quantification operator for quantifying the amount of CO₂ from the CO₂ equivalence parameters for the activity or product uses a monetary value (V).

3. The data processing system according to claim 1, wherein the display and input device has an input mask with input fields for entering the variables.

4. The data processing system according to claim 1, wherein the data memory has an interface to allow the CO₂ equivalence parameters for the activity or product to be changed.

5. The data processing system according to claim 1, wherein the quantification operator determines the amount of CO₂ using the data in the data memory corresponding to the variable or variables.

6. The data processing system according to claim 1, wherein the first and/or second and/or third quantification operator is designed as a shared quantification operator.

7. Data The data processing system according to claim 1, wherein a coupling facility is also provided to activate the production of the determined amount of energy in a power generating plant to correspond to the determined value from the certificate trade or similar, as soon as the value trade takes place.

8. The data processing system according to claim 1, wherein the CO₂ equivalence parameters for the activity and/or product stored in the memory represent a function of the value percentage of GDP of the corresponding activity or the corresponding product.

9. A process for determining, calculating and quantifying a carbon footprint corresponding to an activity and/or a product, and executing an energy-equivalent neutralisation of the same, by means of an electronic value trade or similar, comprising at least one or more of the following steps:
a. Inputting variables into the display and input device in the form of activity and/or product data;
b. Selecting and displaying CO₂ equivalence parameters for the activity or product from the data memory corresponding to the variables;
c. Quantifying the amount of CO₂ that corresponds to the CO₂ equivalence parameter or parameters for the activity or product;
d. Quantifying the amount of energy or determining an energy equivalence parameter, to neutralise the determined amount of CO₂;
e. Quantifying a value corresponding to the determined amount of energy or the energy equivalence parameter and executing a value trade corresponding to the quantified value.

10. The process according to claim 9, wherein the value trade is either a certificate trade, a security trade or similar.

11. The process according to claim 8, wherein, following the value trade, the generation of the previously determined amount of energy corresponding to the determined value from the value trade is activated in a power generation plant.

12. The process according to claim 9, wherein the energy is generated in a renewable power generation plant.

13. The data processing system according to claim 1, wherein said inputted variables are in the form of activity and/or product data.

14. The data processing system according to claim 2, wherein said monetary value (V) is a monetary value for the activity or product determined from the GDP from at least one trade balance.

15. The process according to claim 9, wherein said process uses the data processing system according to claim 1.

16. The process according to claim 12, wherein said renewable power generation plant is a wind turbine generator system, a solar plant, a photovoltaic system or similar.
